(19) United States
(12) Patent Application Publication
(10) Pub. No.: US 2004/0173018 A1
(43) Pub. Date: Sep. 9, 2004

(54) Navigation apparatus

(76) Inventor: Andrew Wilson Lees, Reading (GB)

Correspondence Address: ROBERT W. J. USHER, PATENT AGENT, 1133 BROADWAY, #1515, NEW YORK, NY, 10010

(21) Appl. No.: 10/731,694

(22) Filed: Dec. 8, 2003

(30) Foreign Application Priority Data
Dec. 6, 2002 (GB) 0228496.6

(51) Int. Cl. G01F 1/00

(52) U.S. Cl. 73/170.07

(57) ABSTRACT

Apparatus for navigating an aircraft combines a protractor which has range markers for measuring distance and bearing on an aeronautical map; a speed chart having speed arcs at intervals from a fixed point and representing different aircraft speeds, a plurality of deviation angle lines at angular intervals from the fixed point and about a course line, and record areas for recording results; a customising sheet from which a speed arc cut out portion to match the speed of the aircraft can be cut and attached to the appropriate speed arc on the speed chart; and a ruler for converting between aeronautical map standards. The whole co-operate to readily calculate the compass bearing on which to fly an aircraft despite wind and calculate the aircraft's ground speed. The speed chart and protractor can be a block sliding within a transparent sleeve. Colours of adjacent elements are bright for good visibility.

### FIELD OF THE INVENTION

The present invention relates to an apparatus for use in navigation of an aerial vessel such as an aircraft or an airship, is equally applicable to a marine vessel, and particularly relates to apparatus for use when other navigational aids such as GPS position detection and course determination systems are nonfunctional.

The following description is directed mainly towards aerial craft. It is to be understood that the invention is also applicable to water craft which can be in a marine (salt water) environment or can be in a freshwater environment such as a large lake.

### BACKGROUND OF THE INVENTION

Modern aerial and marine navigation tends to use GPS satellite position determination systems, often coupled with data processing means whereby a course is calculated for the craft and deviations from the planned course communicated to the pilot or steersman.

This is to be lauded for making the problems of adequate navigation amenable to use by persons who would otherwise find extreme difficulty therein. However, in the event of equipment failure, often for as simple a reason as internal equipment batteries being flat, a dire and urgent necessity arises to be able to navigate the craft at least sufficiently well to enable arrival at a suitable landing place. The present invention seeks to provide and exceed this ability.

It requires close concentration to fly an aerial craft such as a light aircraft, which often lacks an autopilot and other aids regularly found in larger aircraft, and the pilot is very often alone and cannot call upon a companion for assistance. Equally, a water craft in choppy or windy/raining conditions requires much instant management. Times for providing the details of a required course are often short, because of the speed of the aircraft. Any navigational aid must be capable of providing the necessary answers using a minimum amount of pilot's or steersman's attention and time. The present invention seeks to provide just such a device.

Need for a navigational aid often can accompany power failure with concomitant loss of lighting. This is no problem during broad daylight, but during darkness or poor weather conditions, even emergency lighting makes reading and distinguishing detail a difficult procedure. The present invention seeks to provide a navigation apparatus which maximises readability while minimising the amount of detail and still allows a level of navigational ability in excess of that required.

The world of light aircraft aviation and sailing enjoys a plethora of different standards of distance scales for aeronautical maps and standards for measuring distance and velocity. The present invention seeks to make easier the translation between one standard and another.

According to a first aspect, the present invention comprises a protractor comprising: a centre point; a plurality of spaced range indication lines spaced at predetermined distances from said centre point; a base line, passing through said centre point; and a plurality of spaced angle indication lines indicating predetermined angular displacements about said centre point and starting with said base line.

According to another aspect, the present invention comprises a speed chart comprising: a selectable one of a plurality of circular speed arcs, each speed arc being representative of a particular velocity of a craft through its medium by distance of each speed arc from a fixed point; a course line, passing through said fixed point, intersecting each of said plurality of speed arcs, and being operative to indicate the direction of geographical travel of the craft; and a plurality of deviation angle lines, indicative of angular deviation about said fixed point of the direction of travel of the craft from moving along said course line; whereby the velocity of drift is represented by the distance between the point where said deviation angle line intersects that one of said plurality of speed arcs which represents the speed of the craft and a point on said course line representative of the geographical speed of the craft; and whereby the angular deviation of the drift direction from the course represented by said course line is represented by the angle between said course line and the line between the point of intersection of said deviation angle line and that one of said plurality of speed arcs which represents the speed though the medium of the craft and the point on said course line representative of the geographical speed of the craft.

According to another aspect, the present invention comprises a speed chart comprising: a speed arc, representative of the speed the speed through its medium of a craft by distance from a fixed point; a course line, passing through said fixed point and intersecting said speed arc, operative to indicate the geographical direction of the craft; and a plurality of deviation angle lines, indicative of angular deviation about said fixed point of the craft from moving along said course line; whereby the velocity of drift is represented by the distance between the representation of the craft geographical speed on said course line and the point of intersection of the deviation angle line of the craft with said speed arc; and whereby the angular deviation of the drift direction from the course represented by said course line is represented by the angle between said course line and the line from the representation of the geographical speed on said course line and the point of intersection of the deviation angle of the craft with said speed arc.

According to another aspect, the present invention consists in an apparatus comprising a speed chart and a protractor: said speed chart including a speed arc, representative of the speed of a craft through its medium by distance from a fixed point; said speed chart further comprising a course line, passing through said fixed point and intersecting said speed arc, operative to indicate the geographical direction of the craft; said speed chart further comprising a plurality of deviation angle lines, indicative of angular deviation about said fixed point of the movement of the craft from moving along said course line; said protractor comprising a centre point; said protractor further comprising a plurality of spaced range indication lines spaced at predetermined distances from said centre point; said protractor further comprising a base line, passing through said centre point; and said protractor further comprising a plurality of spaced angle indication lines indicating predetermined angular displacements about said centre point and starting with said base line; said protractor being operative to measure the velocity of drift by measuring the distance between the representation of the geographical speed along said course line and the point of intersection of the deviation angle of the craft with said speed arc; and said protractor being operative to measure the angular deviation of the drift direction from the course represented by said course line by measuring the angle between said course line and the line from the representation of the geographical speed on said course line and the point of intersection of the deviation angle of the craft with said speed arc.

The invention further provides that the protractor can be one hundred and eighty degrees or three hundred and sixty degrees in angular extent.

The invention also provides that the speed chart and the protractor can be mounted on one or other of a transparent sleeve and a block, said block being slideable within said sleeve to position the centre point of the protractor at the representation of the geographical speed on said course line

The invention further provides that the speed arc can be one of a plurality of speed arcs, each representative of a different speed of the craft though its medium, and that customising sheet can comprise a plurality of detachable cutout portions, each of said plurality of cutout portions corresponding in shape and size to a respective one of said plurality of speed arcs, and that cutout portion, corresponding to that speed arc which represents the speed of the craft through its medium, being detachable from said customising sheet and affixable onto that speed arc which represents the speed of the craft through its medium.

The invention further provides that the speed chart can comprise only indications of speed along the course line, that the customising sheet can comprise a plurality of detachable cutout portions, each of said plurality of cutout portions corresponding in shape and size to a respective one of the plurality of possible speed arcs, and that the cutout portion, corresponding to that speed which represents the speed of the craft through its medium, being detachable from said customising sheet and affixable onto that speed indication which represents the speed of the craft through its medium to provide a speed arc for the speed chart.

The invention further provides that calibration numbers can be provided on the speed chart, the calibration numbers being indicative of the time to cover unit geographical distance at the particular speed shown for each calibration number.

The invention further provides a scale conversion ruler, to provide conversion between the various standards used in aviation, the ruler comprising a plurality of parallel different scales measuring from a common base line, and that the scales can be representative of statue miles, nautical miles, and centimetres.

The invention further provides that the protractor is further operative to measure course and distance between two points from a map.

The invention further provides that adjacent range indication lines in the protractor can be in contrasting bright colours, that the bright colours can be primary colours, and that the primary colours can include one, all or some of red, green, blue, cyan, magenta and yellow.

The invention further provides that adjacent angle indication lines in the protractor can be in contrasting bright colours, that the bright colours can be primary colours, and that the primary colours can include one, all or some of red, green, blue, cyan, magenta and yellow.

The invention further provides that adjacent deviation lines in the chart can be in contrasting bright colours, that the bright colours can be primary colours, and that the primary colours can include one, all or some of red, green, blue, cyan, magenta and yellow.

The invention further provides that adjacent speed arcs in the speed chart can be in contrasting bright colours, that the bright colours can be primary colours, and that the primary colours can include one, all or some of red, green, blue, cyan, magenta and yellow.

The invention further provides that adjacent scales on the ruler can be in contrasting bright colours, that the bright colours can be primary colours, and that the primary colours can include one, all or some of red, green, blue, cyan, magenta and yellow.

The invention further provides that cut out portions, from the customising sheet, bright colours that contrast with the the speed chart, that the bright colours can be primary colours, and that the primary colours can include one, all or some of red, green, blue, cyan, magenta and yellow.

The invention further provides that the craft can be an aerial craft, that geographical speed can be ground speed, and that drift can be wind.

The invention further provides that the craft can be a vessel for passage upon water, that the geographical speed can speed across the fixed surface of the earth, and that drift can comprise one, all or some of wind, tides and currents.

### BRIEF DESCRIPTION OF THE DRAWINGS

The invention is further explained, by way of example, by the following description, which concentrates upon aeronautical navigation, but which should be understood not to exclude navigation upon water, the description to be read in conjunction with the appended drawings, in which:

FIG. 1 shows an example of a typical aeronautical map.

FIG. 2 shows a protractor, according to the present invention.

FIG. 3 illustrates how the protractor of FIG. 2 can be used to find the course and distance between the departure and arrival points on the map of FIG. 1.

FIG. 4A shows a first version of an exemplary ground speed chart, according to the present invention.

FIG. 4B a second version of an exemplary ground speed chart, according to the present invention.

FIG. 4C shows the chart of FIG. 4B on a sheet, for use in a cockpit.

FIG. 5 shows a customising sheet and means to employ a cut our portion from the customising sheet to customise the ground speed chart of FIG. 4 to the particular aeronautical vessel in which it is employed.

FIG. 6 shows the basic vector calculation for which the ground speed chart of FIG. 4 is employed.

FIG. 7 shows the ground speed chart of FIG. 5 with actual results entered thereon.

FIG. 8 shows how the protractor of FIG. 2 can be used to determine the speed and relative angle of the wind vector.

FIG. 9 shows how the actual wind vector's compass bearing and speed can be entered into the recording disc of the ground speed chart.

FIG. 10 shows an alternative embodiment of the protractor and ground speed chart where one-handed operation is possible.

FIG. 11 shows a scale conversion ruler, for use in converting the several scales used by light aircraft aviators.

FIG. 12 shows an alternative form of the protractor, this time in a three hundred and sixty degree form.

And

FIG. 13 shows an alternative form of the protractor, this time in a ninety degree form.

### PARTICULAR DESCRIPTION

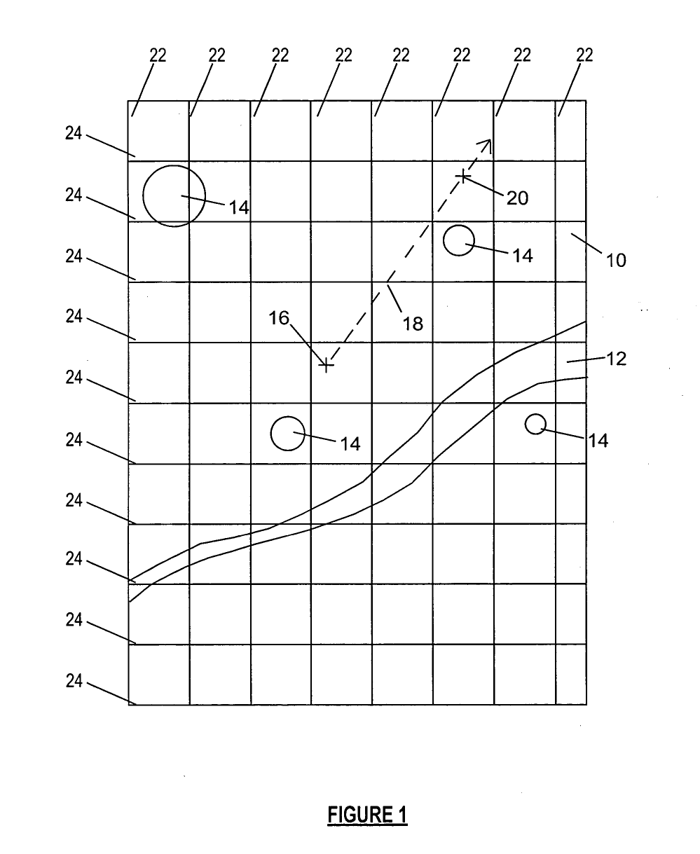

Attention is drawn to FIG. 1 showing a typical example of an aeronautical map 10 showing items of interest or concern to an aviator such as rivers 12, urbanised areas 14 and other items, not shown, such as hilltops (with heights), power lines and transmitter masts, to name but a few. When planning a route, the aviator leaves a departure point 16 and plans to move along a bearing 18 to an arrival point 20. To make the journey, the aviator requires to know the compass setting to follow the bearing 18 and the distance between the departure point 16 and the arrival point 20, used to calculate the time that the transit time between the departure point 16 and the arrival point 20.

The aeronautical map 10 comprises longitude grid markings 22 and latitude grid markings 24 which appear, over a short distance, to define rectangular areas. However, the longitude grid markings 22 become closer together on the aeronautical map the further north they are.

It the present invention is applied to vessels for passage upon water, the aeronautical map of FIG. 1 becomes a coastal or other chart for use with such vessels.

All of this is fine and easy to do if GPS devices are used, or if a simple route in fine and light conditions is undertaken. Alas, all too often instruments fail, lighting becomes poor or non existent, and an airfield, which was intended as the landing point, turns out to be closed. Such circumstances mean that the aviator has his original landing point as the point of departure 16 in FIG. 1, and a nearby alternative airfield as the arrival point 20 in FIG. 1, with precious little time to work out how to get there, if he can because he needs at least one hand to fly his aircraft and needs to look where he is going, rather than consult charts and maps. It is under these circumstances that the present invention comes into maximum utility by providing clear and rapid answers with minimum interference to the activity of flying and controlling the aircraft. This is particularly of use in, for example, microlight aircraft, where autopilots and other aids are unlikely to be present. In the case of vessels for use upon water, the failure of instruments can be equally catastrophic.

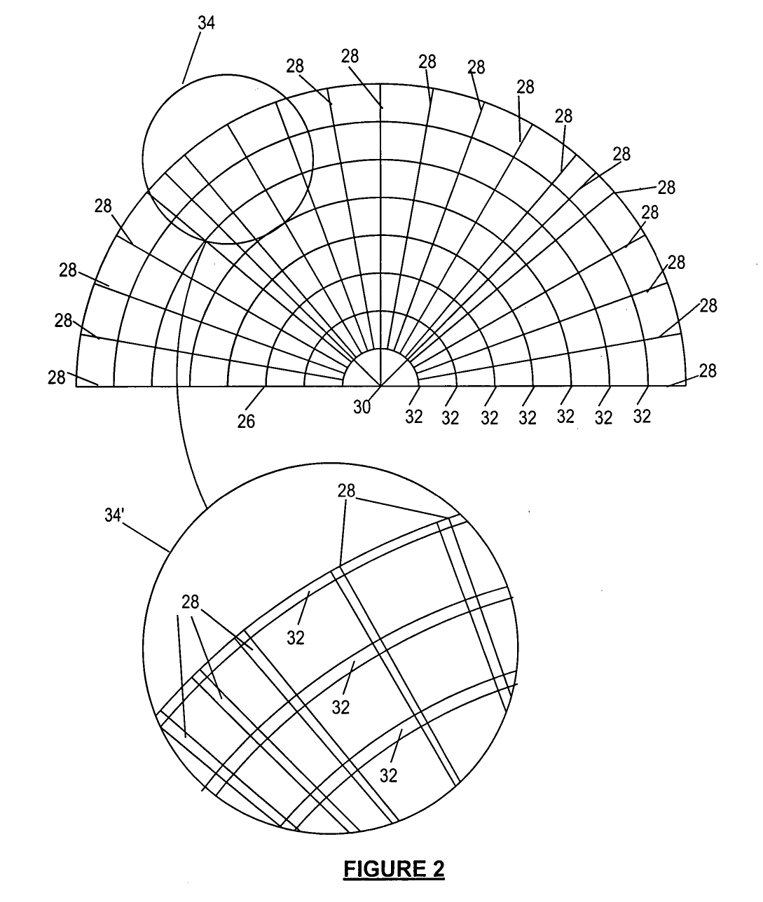

Attention is next drawn to FIG. 2 which shows a protractor 26, according to the present invention. The first thing to notice is that the protractor is devoid of numerical markings. Instead of angular numerical indications, the protractor 26 is provided with spaced angle markers 28. In this example, for preference and easy reading and interpolation, the angle markers 28 are provided at ten degree intervals with an extra angle marker at the forty-five degree and at the one hundred and thirty five degree angles so that confusion, at a glance, can be avoided in the estimation as to what angle about a centre 30 is intended to be represented by each angle marker 28.

The next thing to notice is that the protractor 26 comprises range markers 32, spaced at equal intervals from the centre 30. These range markers 32 have a known relationship to markings on the ground speed chart, which is later described, and to the distances on the aeronautical map 10.

Magnified Detail 34 34′ of FIG. 2 shows a small portion of the surface of the protractor, which is made of transparent material. Each of the range markers 32 comprises transparent coloured material through which the aeronautical map 10 or the ground speed chart is visible. The adjacent range markers 32 are in bright and contrasting primary colours, such as red, blue, green, cyan, magenta and yellow to name but a few, so that the range markers can readily be seen, and told apart, in poor visibility or in situations where viewing is, of necessity, brief in time. The colours can also comprise reflective or fluorescent elements, further to enhance their visibility.

Each of the angle markers 28 also comprises transparent coloured material through which the aeronautical map 10 or the ground speed chart is visible. Adjacent angle markers 28 are in bright and contrasting primary colours, such as red, blue, green, cyan, magenta and yellow to name but a few, so that the angle markers 28 can readily be seen, and told apart, in poor visibility or in situations where viewing is, of necessity, brief in time. The colours can also comprise reflective or fluorescent elements, further to enhance their visibility.

The requirement for United Kingdom Patent applications to be provided with figures in black line on white background makes representation of the full effect of this mixture of coloured indicia difficult to convey. The imagination and vision of the reader is relied upon to recreate and appreciate the full and somewhat visually startling effect.

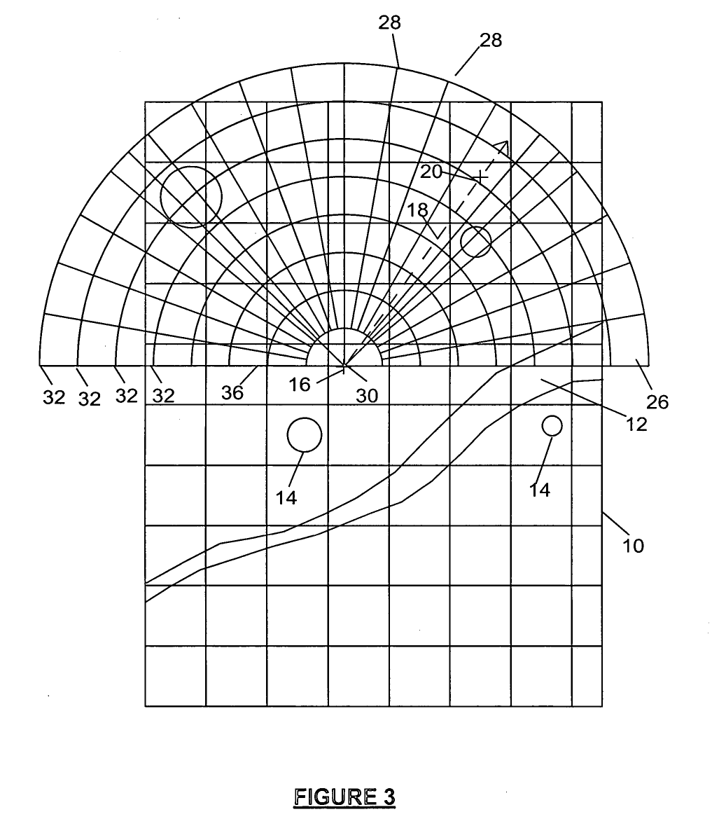

Attention is drawn to FIG. 3, showing a first stage in the process of setting a course to make the journey from the departure point 16 to the arrival point 20.

The protractor 26 is placed upon the aeronautical map 10 with the centre 30 coincident with either the departure point 16 or with the arrival point 20. The protractor 26 possesses a base line 36 which can be aligned parallel to either the longitude grid markings 22 or to the latitude grid markings. The only requirement is that the arrival point 20 and the departure point 16 both fall within the area covered by the protractor 26. The bearing 18 and the distance between the departure point 16 and the arrival point 20 can be read from the protractor. The bearing is given by on which or between which the particular angle markers 28 the bearing lies. The example given in FIG. 3, where the principal angle markers are ten degrees apart, shows that the bearing 18 lies a little clockwise of midway between thirty degrees and forty degrees. In this example, then, the bearing is, to within around three percent accuracy, thirty six degrees.

The bearing direction finding operation of the protractor 26 on the aeronautical map 10 is quite empirical. The human eye is quite capable of making two lines parallel to within a third of a degree or better. The reader is asked to check this using angles, distance measurements and trigonometry or to consult any builder or carpenter. It is a little known fact that the human eye is so acute, as it is in subdividing scales to a tenth or better. Thus, an adequately accurate bearing, accurate to about one degree, is quickly obtained by use of the protractor. A one or two second glance should suffice to do this.

Likewise, the distance can be found using the range markers 32 on the protractor 26. In the example given, the distance between each adjacent pair of range markers 32 is taken to be five miles (around 8 kilometres). Thus the example given in FIG. 3 shows the distance between the departure point 16 and the arrival point 20 to be six and two tenth units, which, by easy mental arithmetic, works out to be thirty one miles (around 50 kilometres) to within around one half of a mile (about 800 metres) accuracy.

A quick lining up of the protractor 26 on the map, in any one of a number of possible orientations, thus allows the aviator, within a very few seconds, to obtain a course or bearing along which to fly to within one degree and a distance to within one and a half percent (in the example given).

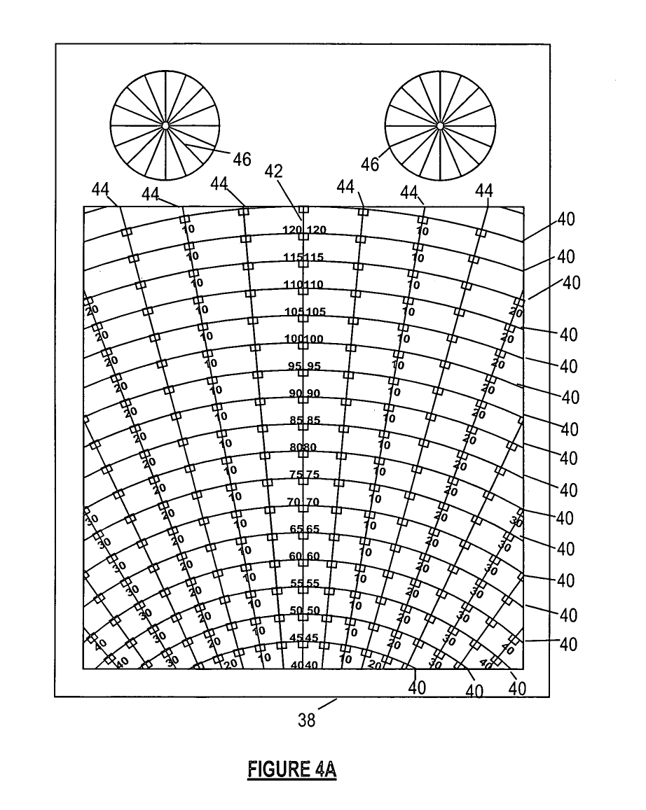

Attention is next drawn to FIG. 4A, which shows a first example of a speed chart 38 according to the present invention.

The speed chart 38 is, conveniently, provided in the form of a multi sheet tear-off pad where a used speed chart 38 can be discarded to present a fresh speed chart 38 for use.

The speed chart 38 comprises a plurality of spaced constant velocity circular arcs 40, each having a common centre and whose distance from that centre is in proportion to the speed represented. These air speed arcs 40, in this example, start at 40 miles per hour (around 64 kilometres per hour) as this is about the slowest speed that can be sustained by a light, propeller driven winged aircraft, and stop at about 130 miles per hour (around 210 kilometres per hour) being representative of the maximum cruising speed to be expected of a light, propeller driven winged aircraft. Other ground speed charts can be made for faster propeller driven or jet aircraft and for slower airships. The ground speed chart 38 can be trimmed to match the range of expected conditions. A similar chart can be constructed for vessels that proceed on water.

The aviator usually has a kneeboard, a flat document holder which is strapped to the knee, above the joint, so that documents are visible when the aviator sits in the aircraft. The ground speed chart is intended (but not obliged to be) held in the kneeboard and is generally trimmed for a range of airspeeds thirty of forty miles per hour (around fifty to seventy kilometres per hour) either side of the aircraft cruising speed.

A course line 42 extends down the centre of the ground speed chart and the intersecting air speed arcs 40 represent different airspeeds of the aircraft in the direction of the bearing the aircraft is following.

Deviation angle lines 44 are equally angularly spaced on either side of the course line 42 to indicate deviations from the “straight ahead” position indicated by the course line 42. In this example the deviation angle lines are angularly spaced by five degree increments, though other spacings, even on equal spacings, are possible.

Just like the angle markers 28 and the range markers 32 on the protractor 26, the speed chart 38 also comprises coloured areas and items. Adjacent deviation angle lines 44, and adjacent air speed arcs 40 are in bright and contrasting primary colours, such as red, blue, green, cyan, magenta and yellow to name but a few, so that the deviation angle lines 44 and the speed arcs 40 can readily be seen, and told apart, in poor visibility or in situations where viewing is, of necessity, brief in time. The speed chart 38 also comprises coloured areas, for example, to distinguish between the right hand side and the left hand side thereof. The colours used can also comprise reflective or fluorescent elements, further to enhance their visibility.

The speed chart 38 also comprises one or more record areas 46 which can be used by the aviator to record information relating to or derived from the speed chart 38, in a manner later to be described.

The speed chart 38 can show calibration numbers, as indicated in FIG. 4 and hereafter, or can equally be devoid of calibration numbers as will later become clear.

An aircraft has a maximum cruising speed which is set by the motor, the propeller pitch and the throttles. The aircraft proceeds through the air at the airspeed or cruising speed in the direction in which the aircraft is heading. The aircraft will have only one of the air speed arcs which corresponds to its cruising velocity or airspeed. Equally, a vessel for use on water can have a constant “speed in the medium of water” from its engine. A sailing vessel, at any one time, will also have a constant “speed through the water”.

Although the aircraft moves through the air at a fixed speed in a known direction, there is drift derived from the air itself is moving in the form of wind, and thus the aircraft will move a different distance and in a different direction from the path and speed indicated along the line of flight of the aircraft. In the case of a vessel for proceeding upon water, drift can be tides, an ocean or other current, push from wind, or a combination of any of these.

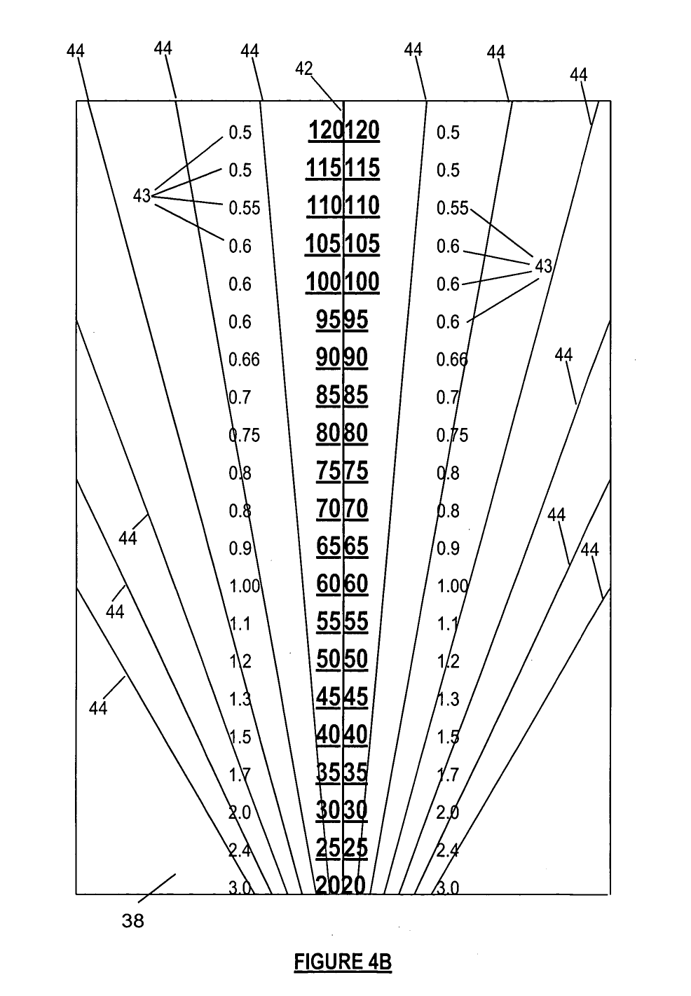

Attention is next drawn to FIG. 4B showing a second style of speed chart 38 where the deviation angle lines 44 and the course line 42 are still shown, but the individual speed arcs are omitted. Speeds are marked along the course line 42, and calibration numbers 43 marked against each speed, each calibration number 43 indicating the number of minutes it would take to move one statute mile (or any other suitable fixed distance) at that particular speed. As will be described with reference to FIG. 5, the second style of speed chart 38 has a cut out portion from a customising sheet attached thereto to provide the appropriate speed arc 40.

Calibration numbers 43 can also be provided on the speed chart 38 shown in FIG. 4A.

Attention is next drawn to FIG. 4C, which shows the second form of speed chart 38 of FIG. 4B on a sheet together with record areas 46, just as is illustrated in FIG. 4A. Hereafter, whatever is later described with reference to the speed chart shown in FIG. 4A is to be understood as being applicable also to the speed chart shown in FIGS. 4B and 4C, and vice versa.

Attention is next drawn to FIG. 5, which shows a customising sheet 48 and means to employ a cut out portion 50 from the customising sheet 48 to customise the speed chart 38 of FIG. 4 to the particular aeronautical vessel in which it is employed.

The customising sheet 48 comprises a plurality of arcuate cut out portions 50, there being one cut out portion 50 for each of the speed arcs 40 on the speed chart 38. The cut out portions 50 are brightly coloured, so as to form a readily visible contrast when a cut out portion 50 is attached to a speed chart 38. Each cut out portion is an exact arcuate facsimile of the corresponding speed arc 40 on the speed chart 38. The cut out portion 50 for the cruising speed of the particular aircraft is selected. The selected cut out portion 50 can then be cut from the customising sheet 48, for example, by scissors 52 and moved as indicated by arrows 54 to be stuck to the speed chart 38. The customising sheet can be printed paper and the cut out portions can be stickable to the speed chart 38 using a separate adhesive. The cut out portions 50 can be separable from the customising sheet 48 by means of perforated lines. The rear surface of the customising sheet 48 can be coated with a moisture activated adhesive. As another alternative, the customising sheet 48 can be in the form of a set of self-adhesive printed labels, each individually peelable from a backing sheet. As another alternative, the customising sheet 48 can be in the form of “sticky-back plastic” which forms much the same sort of item as the self-adhesive printed labels, but with a shiny and cleanable surface.

As earlier stated, one, the other, both or neither of the cutout portions 50 or the speed chart 38 can show numerical calibrations since only one of the cutout portions 50 corresponds to the cruising airspeed of the particular aircraft, the cutout portion 50 can only be conformably adhered to one of the speed arcs 40 on the speed chart 38 since all of the speed arcs 40 have different diameters, and the meanings of the separations between adjacent deviation angle lines 44 and between adjacent speed arcs 40 is known, with ease, to the aviator, without the need for calibration numerals. Equally, if the speed chart 38 of FIGS. 4B and 4C is used, the cut out portion 50 is stuck with its centre on the course line 42 at the appropriate indicated speed to provide the correct and single speed arc 40.

The cutout portion 50 can be opaque, obscuring the speed chart 38 there-beneath, or can be of transparent material which allows vision of the speed chart 38 there-beneath.

Another alternative approach is to have all of the speed arcs 40 present on a waterproof speed chart 38, with the particular speed arc 40 for use in the current circumstances, markable with an earasable coloured marker or chinagraph (TM) pencil. This style is particularly useful for marine vessels, and especially sailing vessels where the “cruising speed” is subject to frequent change.

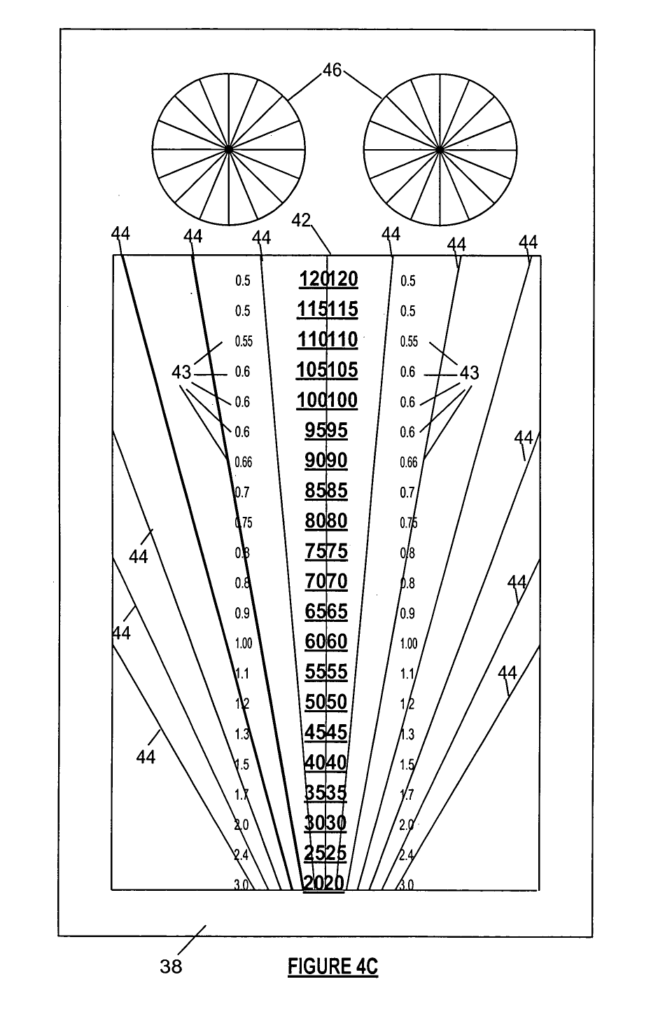

Attention is next drawn to FIG. 6, which shows the basic vector calculation for which the speed chart 38 of FIG. 4 is employed.

An aircraft 56 flies on its compass bearing at a velocity indicated by the length, direction and sense of compass bearing vector 58. The actual ground speed and director on the ground is indicated by the direction, sense and length of a ground speed vector 60 and is the vector sum of the compass bearing vector 58 and a wind speed vector 62 whose length, sense and direction indicate the velocity of the wind. A vector sum is formed by “completing the triangle” as shown in FIG. 6.

The problem to be solved in any aeronautical navigation is to know the direction and speed of the wind. The wind velocity is the difference between the air speed vector 58 and the ground speed vector 60, and is found by the “completion of triangles” method by the protractor 26 measuring points on the speed chart 38, which points are found by observations of the ground in conjunction with the aeronautical map 10. The wind speed vector 62 comprises two components, a head wind vector 59 which opposes the direct flight of the aircraft 56, and a transverse drift vector 61, which pushes the aircraft 56 at ninety degrees to its path. It is to be noted that the head wind vector 59 and the transverse drift vector 61 sum onto the airspeed arc 66 which also passes through the tip of the compass bearing vector 58, has a radius equal to the length of the compass bearing vector 58 and centre at the joining point between the compass bearing vector 58 and the ground speed vector.

The same reasoning applies to vessels for passage upon water. The ground speed and direction corresponds to the geographical speed and direction as measured by taking a pair of time spaced position fixes using the coastal or other chart, and the wind speed and direction corresponds to tidal or sea current drift, together with an element of the vessel being pushed by the sea surface wind.

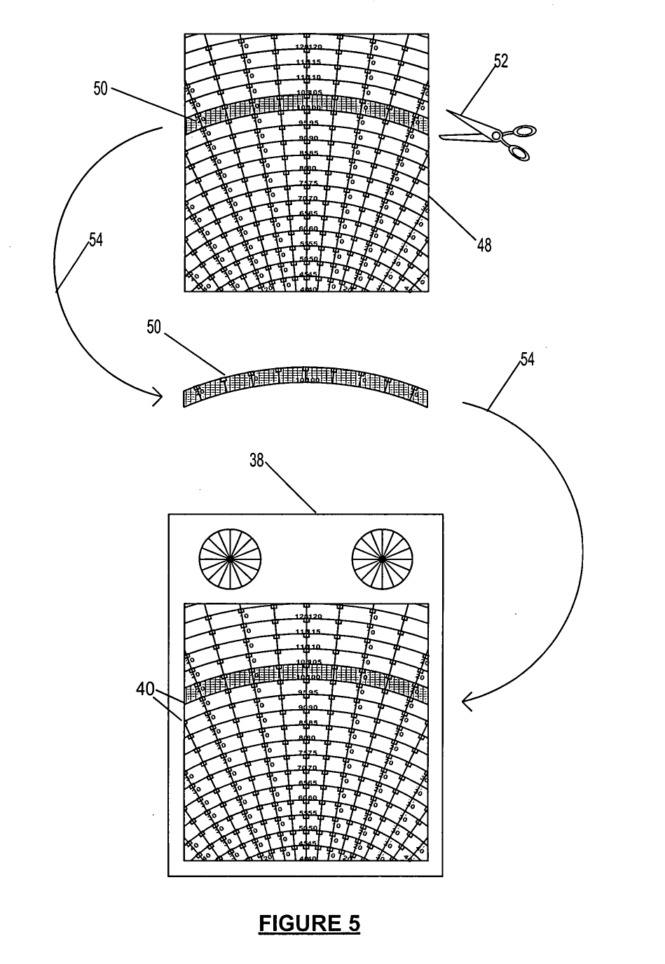

Attention is next drawn to FIG. 7, which shows an exemplary speed chart 38 with exemplary results entered thereon, and is illustrative of the novel and utilitarian manner in which the situation of FIG. 6 is solved for the wind speed vector.

In this example, the aircraft 56 cruises at 100 miles per hour (167 kilometres per hour) and, thus, the 100 miles per hour (167 kilometres per hour) cut out portion 50 from the customising sheet 48 has been stuck at the appropriate speed arc 40 on the speed chart 38.

A course is set between two way points (points on the aeronautical map which should be crossed on the journey.) The direction between the two way points being represented by the course line 42. However, it is noticed that an offset from the direct course has to be flown, represented by the course offset line 64. In order to track along the desired path, the bearing represented by the course offset line 64 has to be flown. Further, by observation of measured ground speed using a GPS receiver, or by use of a stopwatch and observations from the aeronautical map 10, a true ground speed 65 is found, which is plotted on the course line 42. Thus, the only elements which are noted are the deviation of the flown course from the “wind free” course (the course which could be flown if there were no wind) and the true ground speed 65. The ground speed is determined by the time taken to travel between two points. The calibration numbers 43 are then useful to estimate the time taken to make journeys at the measured ground speed.

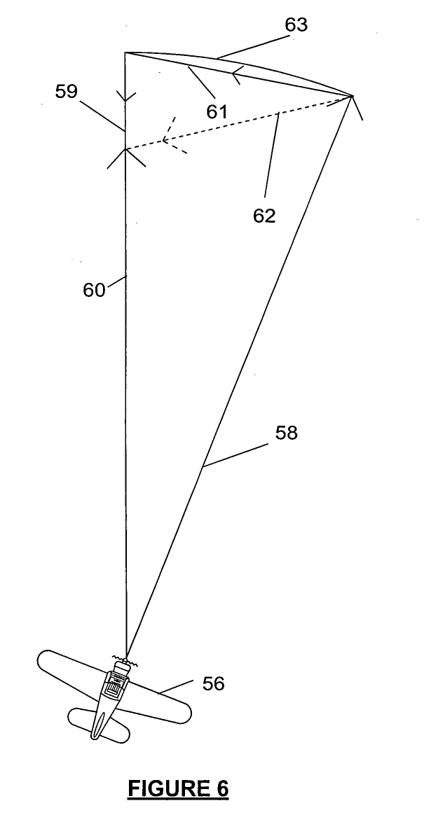

Attention is next drawn to FIG. 8, which shows how the protractor 26 is used to find the wind speed vector 62.

The centre 30 of the protractor 26 is positioned over the representation of the true ground speed 65 on the course line 42. The point of intersection of the course offset line 64 with the selected speed arc 40 is the point whose angle and distance is to be measured. In this example the angle of the wind speed vector 62 to the course line 42 is shown to be around sixty degrees (as measured by the angle markers 28) and the wind speed is shown to be a little under seven units, that is thirty four miles per hour (52 kilometres per hour).

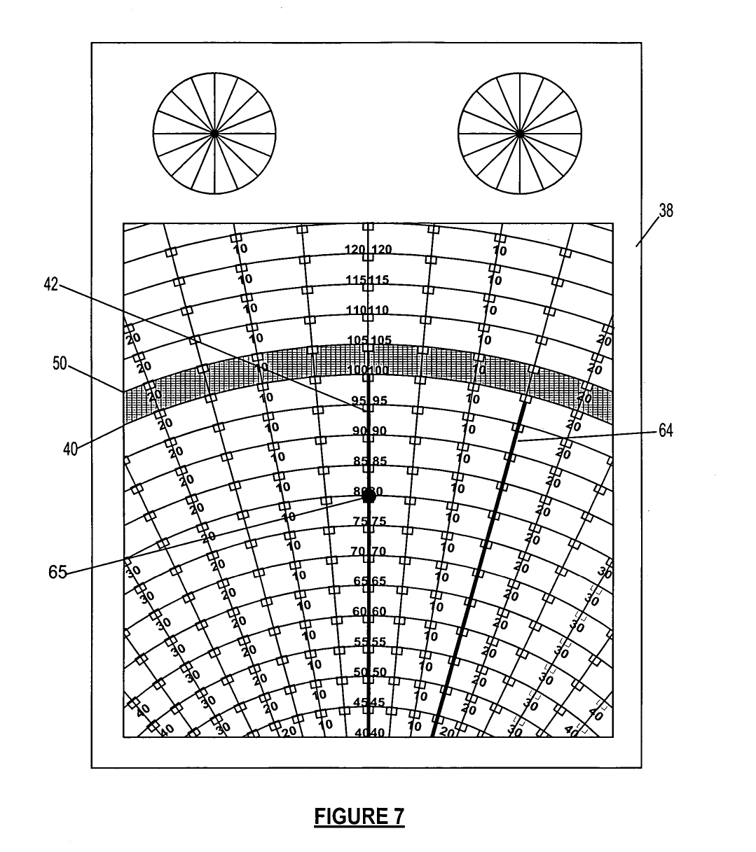

FIG. 9 shows how the results can be plotted on the record areas 46. The record areas 46 each are in the form of an angularly divided circle. The division can be into equal angles (as shown), or can be (as is preferred) into non equal portions such as every thirty degrees interspersed with every ninety degrees. Other division schemes are possible and will be apparent to one skilled in the art. Such information as the desired course direction 70 together with a desired course note 72, for example, giving a written record of the compass degrees of the bearing of the desired course, can be recorded. Equally, the wind speed deviation direction 74, as measured by the protractor 26 with reference to FIG. 8, and a deviation note 76 such as the measured angle, can also be included. Finally, the direction of the actual wind speed vector 78 can be marked together with a written wind speed vector note which can record, for example, the wind speed vector bearing and the speed of the wind. The wind speed vector 78 direction lies in the direction of the sum of the wind speed deviation direction 74 with the desired course direction 70. As another alternative, the speeds and the various directions can each be indicated on the record areas 46 by the directions and length of a line drawn for each item from the centre of the circle in the record area 46.

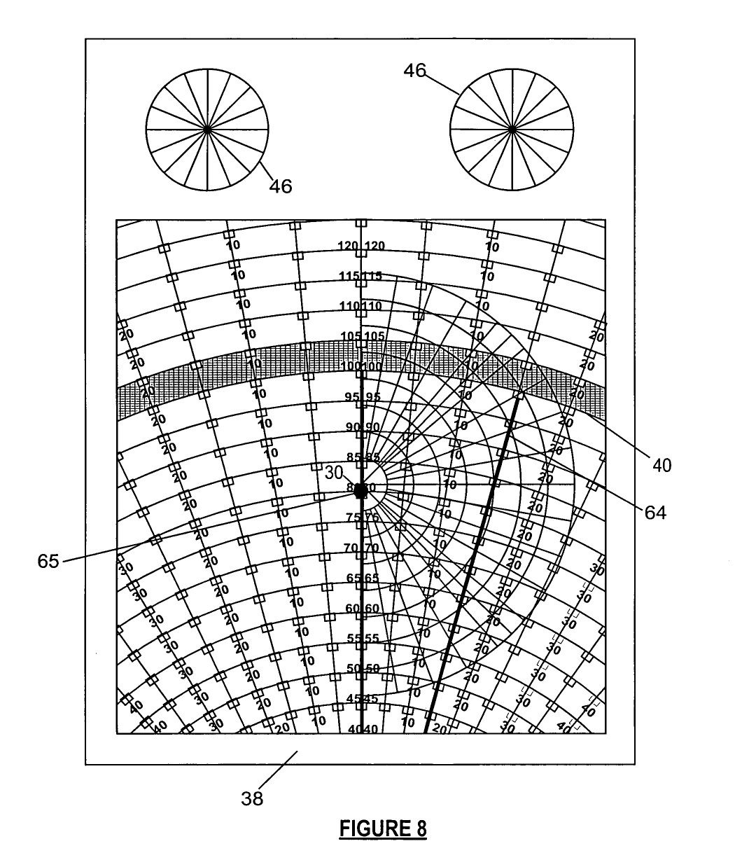

Attention is next drawn to FIGS. 10A, 10B and 10C, showing a further embodiment of the speed chart and compass combination which can be manipulated with only one hand.

In FIG. 10A, the protractor 26 is incorporated by printing or adhesion on the surface of a protractor block 82 which slides within a transparent speed chart sleeve 84 with two end openings 86 and four sides 88. The sleeve 84 comprises one half of the speed chart 38, applied thereto to be superimposed upon the protractor 26 imprinted onto the protractor block 82 when the block 82 is within the sleeve 84. The speed chart 38 can be of either form shown in FIGS. 4A, 4B and 4C. For preference, the form used is that shown in FIGS. 4B and 4C. Both forms, of course, for this use, are provided on only one side of the course line 42.

The selected speed arc 40 is drawn in and one closed edge 90 of the sleeve 84 is aligned with the course line 42 of the one half of the speed chart 38. The protractor 26 is provided on the protractor block 82 such that, when the protractor block 82 is inserted into the sleeve 84 as indicated by arrow 92, the base line 36 and the centre 30 of the protractor 26 slide along and beneath the course line 42 of the sleeve 84.

The block 82 has sufficient rigidity and weight for the block 82 to slide under gravity, or with slight shaking, within the sleeve 84 for the for the protractor 26 be aligned within the sleeve 84 in a selectable position. Alternatively, the block 82 may extend sufficiently beyond the end openings 86 of the sleeve 84 such that one end of the block 82 can be placed against the aviator's knee (or other static element) and the sleeve 84 moved up and down by the single hand of the aviator, once again for the protractor 26 be aligned within the sleeve 84 in a selectable position. Equally, the block 82 can be spring loaded within the sleeve, and the correct registration of block 82 and sleeve 84 achieved by, with one hand, holding the sleeve 84 and pushing upon the block 82 with one or more fingers.

FIG. 10A shows how the block 82 slides into the sleeve 84.

FIG. 10B shows how the centre 30 of the protractor 26 can be aligned with the representation of the true ground speed 65 on the course line 42 to make the measurements illustrated and described with reference to FIG. 8. Here the aviator must be aware of the general direction of the wind, and transpose, if necessary, the measure wind speed vector 62 into the correct quadrant of the compass.

FIG. 10C shows how the protractor 26 can slide so that its centre point 30 lies in alignment with the selected speed arc 40.

FIG. 10D generally shows how the block 82 can be slid beyond the point of alignment shown in FIG. 10B

An alternative embodiment has the speed chart 38 on the block 82 and the protractor 26 on the sleeve 84.

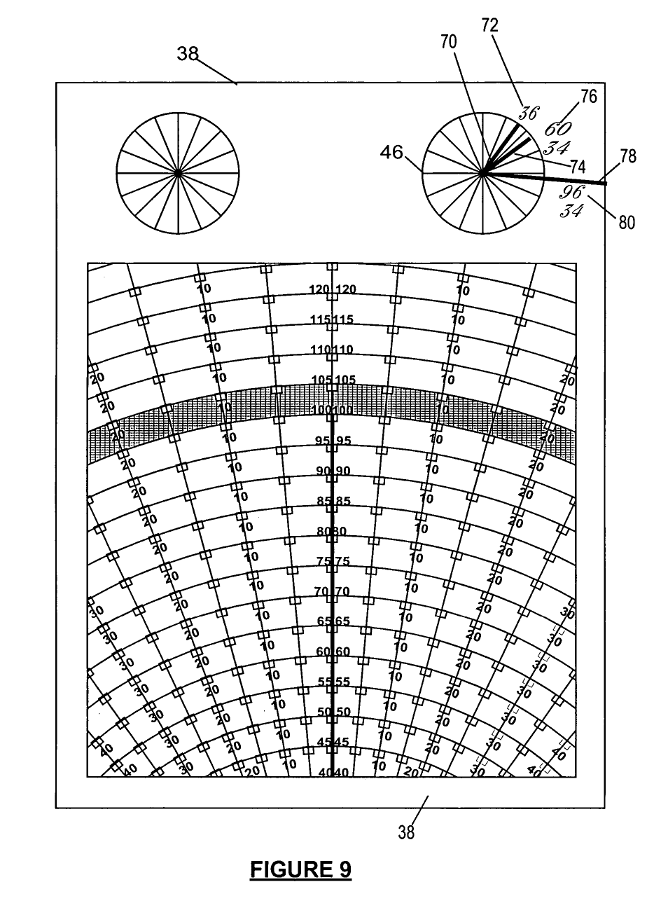

FIG. 11 shows a ruler 94 used in conjunction with the aeronautical map 10, and the speed chart, to convert between the plethora of standards for map scales and airspeeds used in light aviation. The ruler 94 is made of transparent material and comprises a centimetre scale 96, a nautical mile scale 98, and a statute mile scale 100. Adjacent scales 96 98 100 are of bright and/or contrasting colours which can include clear, red, yellow, green, cyan, magenta and yellow, to name but a few. The ruler 94 can also be used to assist in navigating vessels for proceeding upon water

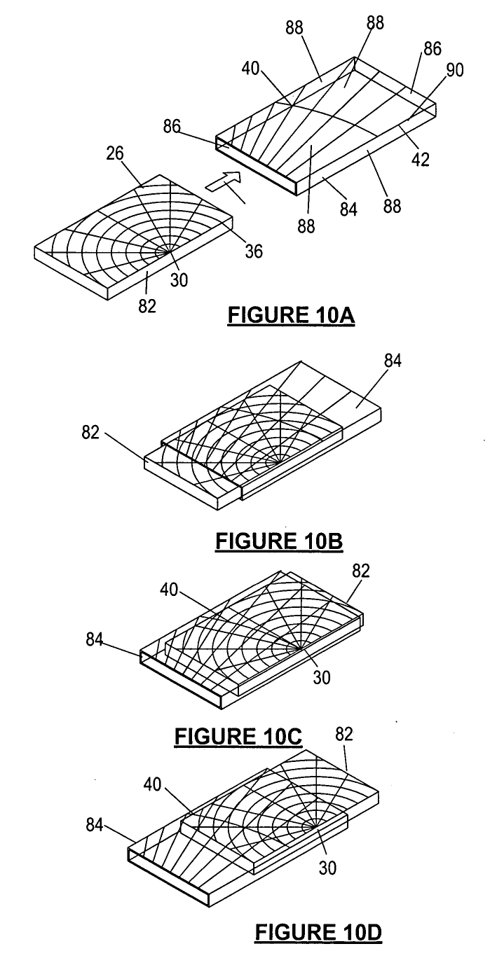

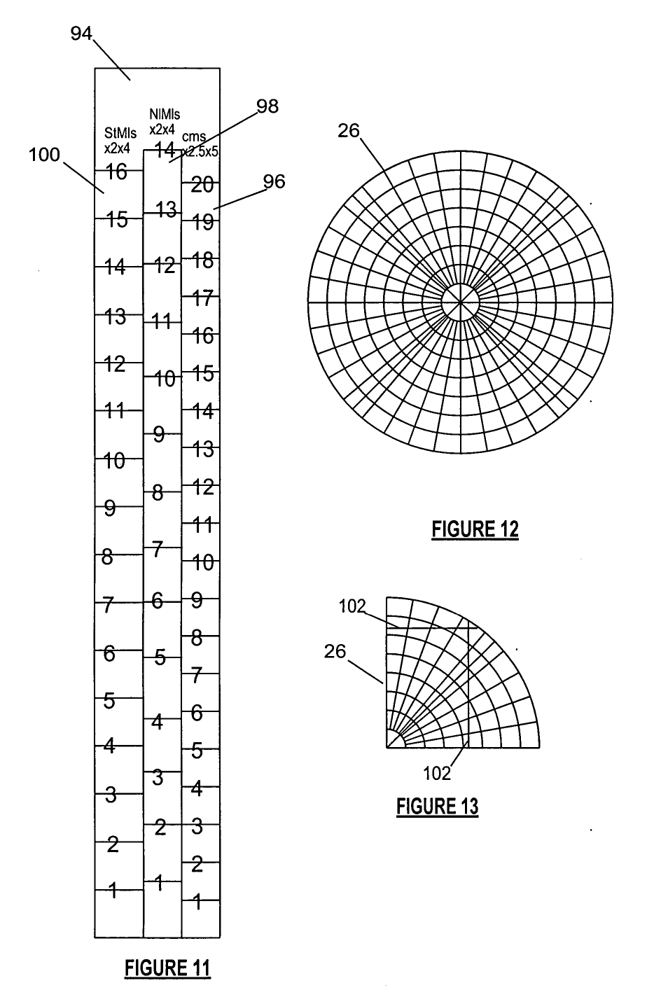

Finally, attention is drawn to FIG. 12 and FIG. 13, where FIG. 12 shows how the protractor 26 can be provided as a first alternative in the form of a three hundred and sixty degree version, and where FIG. 13 shows how the protractor 26 can be provided as a second alternative in the form of a ninety degree version (a quadrant) with additional alignment lines 102 provided thereon to assist with aligning the protractor on charts and maps. The circular form of FIG. 12 could be considered too large for a cramped cockpit, and the quadrant form of FIG. 13 a little small for manipulation with gloves in a cold cockpit. However, where space is plentiful, the circular version of FIG. 12 is ideal, and where space is at a premium, the quadrant form of FIG. 13 is very useful. The alignment lines 102 can also be provided on the semicircular and full circle forms of the protractor 26.

In the case of the protractor 26 and the ruler 94 for use in vessels for proceeding upon water, both of these items can be made of material which floats upon water, or can be provided with buoyant element, so that they are recoverable if they slip beneath a water surface.

Priority under 35USC119 is claimed from /GB 0228496.6 the disclosure of which is incorporated herein by reference.

1. An apparatus comprising a speed chart and a protractor, said speed chart comprising: at least one speed arc representative of at least one airspeed of an aircraft by at least one distance from a fixed point and markings representative of ground speeds of the aircraft by distances from said fixed point; said speed chart further comprising a compass bearing line, passing through said fixed point and intersecting said at least one speed arc, operative to indicate a direction of flight of the aircraft; said speed chart further comprising a plurality of deviation angle lines, indicative of angular deviation about said fixed point of the flight of the aircraft from flying along said compass bearing line; said protractor comprising a centre point; said protractor further comprising a plurality of spaced range indication lines spaced at predetermined distances from said centre point; said protractor further comprising a base line, passing through said centre point; and said protractor further comprising a plurality of spaced angle indication lines indicating predetermined angular displacements about said centre point and starting with said base line;
said protractor being operative to measure a velocity of wind by aligning the baseline of the protractor along said compass bearing line with the centre point of the protractor coincident with one of the markings representative of an actual ground speed of the aircraft, and with a deviation angle line of the speed chart representing a deviation angle of the aircraft intersecting a selected one of said at least one speed arc representative of the airspeed of the aircraft and, measuring a distance between the centre point and a point of intersection of the deviation angle line with the selected one speed arc; and,
said protractor being operative to measure an angular deviation of wind direction from a course represented by said compass bearing line by measuring an angle of an angle indication line which intersects the point of intersection of the angle deviation line representing a deviation angle of the aircraft with the selected one speed arc.

2. An apparatus, according to claim 1, wherein said speed chart and said protractor are mounted, each upon a different one of a transparent sleeve and a block, said block being slidable within said sleeve to position the centre point of the protractor at the point of intersection of the selected one speed arc representative of the airspeed of the aircraft with the compass bearing line.

3. An apparatus, according to claim 1, wherein said speed chart and said protractor are mounted each upon a different one of a transparent sleeve and a block, said sleeve and said block being fixed in relationship to one another with the centre point of the protractor at the point of intersection of the selected one speed arc representative of the airspeed of the aircraft with the compass bearing line.

4. An apparatus, according to claim 1, wherein said protractor is fixed upon a surface of said speed chart with the centre point of the protractor at the point of intersection of the selected one speed arc representative of the airspeed of the aircraft with the compass bearing line.

5. An apparatus, according to any one of the preceding claims, wherein said at least one speed arc comprises a plurality of speed arcs, each speed arc of said plurality of speed arcs being representative of a different airspeed of the aircraft, said apparatus further comprising: a customising sheet having a plurality of detachable cutout portions, each of said plurality of cutout portions corresponding in shape and size to a respective one of said plurality of speed arcs; a cutout portion, corresponding to a speed arc which represents the airspeed of the aircraft being detachable from said customising sheet and affixable onto a speed arc which represents the airspeed of the aircraft.

6. An apparatus, according to claim 5, wherein said protractor covers one hundred and eighty degrees in angular extent.

7. An apparatus, according to claim 5 wherein said protractor covers three hundred and sixty degrees in angular extent.

8. An apparatus, according claim 5, wherein said protractor is further useable to measure course and distance between two points on an aeronautical map.

9. An apparatus, according to claim 1, further comprising a scale conversion ruler, operative to provide conversion between aviation map standards, said ruler comprising a plurality of different parallel scales measuring from a common base line.

10. An apparatus, according to claim 9, wherein said scales are representative of at least two of: statute miles; nautical miles; and centimetres.

11. An apparatus, according to claim 10, wherein at least one of: adjacent range indication lines in the protractor; adjacent angle indication lines in the protractor; the cut out portions from the customising sheet and the speed arcs on the speed chart; adjacent deviation lines in the speed chart; adjacent speed arcs in the chart; and adjacent scales on the ruler; are in contrasting bright colours.

12. An apparatus, according to claim 11, wherein said bright colours are primary colours, including at least two of red, green, blue, cyan, magenta and yellow.

13. A scale conversion ruler, for providing conversion between standards used in aviation maps, said ruler comprising a plurality of different parallel scales measuring from a common base line, and said scales being representative of at least two of statute miles, nautical miles, and centimetres.

14. A ruler, according to claim 13, wherein adjacent scales are in contrasting bright colours.

15. A ruler, according to claim 14, wherein said bright colours are primary colours, including at least two of red, green, blue, cyan, magenta and yellow.

16. A protractor comprising: a centre point; a plurality of spaced range indication lines spaced at predetermined distances from said centre point; a base line, passing through said centre point; and a plurality of spaced angle indication lines indicating predetermined angular displacements about said centre point and starting with said base line.

17. A protractor, according to claim 16, wherein at least one of adjacent range indication lines in the protractor, and adjacent angle indication lines in the protractor, are in contrasting bright colours.

18. A protractor, according to claim 17, wherein said bright colours are primary colours, comprising at least two of red, green, blue, cyan, magenta and yellow.

19. A speed chart comprising: a selectable one of a plurality of circular speed arcs, each speed arc being representative of a particular velocity of an aircraft by distance of each speed arc from a fixed point; a compass bearing line, passing through said fixed point, intersecting each of said plurality of speed arcs, and being operative to indicate a direction of flight of the aircraft; and a plurality of deviation angle lines, indicative of angular deviation about said fixed point of the flight of the aircraft from flying along said compass bearing line; whereby a velocity of wind is represented by a distance between the point where said compass bearing line intersects one of said plurality of speed arcs which represents a ground speed of the aircraft and a point of intersection of a deviation angle of the aircraft with one of said plurality of speed arcs which represents the airspeed of the aircraft; and whereby an angular deviation of wind direction from a course represented by said compass bearing line is represented by an angle between a tangent on that one of said plurality of speed arcs which represents the airspeed of the aircraft at the point where said compass bearing line intersects that one of said plurality of speed arcs which represents the airspeed of the aircraft and the point of intersection of the deviation angle of the aircraft with that one of said plurality of speed arcs which represents the airspeed of the aircraft.

20. A speed chart, according to claim 19, wherein at least one of adjacent deviation lines in the speed chart and adjacent speed arcs in the chart are in contrasting bright colours.

21. A speed chart, according to claim 20, wherein said bright colours are primary colours, include at least two of red, green, blue, cyan, magenta and yellow.

22. A speed chart comprising: a speed arc, representative of an airspeed of an aircraft by distance from a fixed point; a compass bearing line, passing through said fixed point and intersecting said speed arcs, operative to indicate a direction of flight of the aircraft; and a plurality of deviation angle lines, indicative of angular deviation about said fixed point of the flight of the aircraft from flying along said compass bearing line; whereby a velocity of wind speed is represented by a distance between a point where said compass bearing line intersects said speed arc and a point of intersection of the deviation angle of the aircraft with said speed arc; and whereby the angular deviation of the wind direction from a course represented by said compass bearing line is represented by an angle between a tangent on said speed arc at the point of intersection of speed arc and said compass bearing line and the point of intersection of the deviation angle of the aircraft with said speed arc.

23. A speed chart, according to claim 22, adjacent deviation lines in the speed chart are in contrasting bright colours.

24. A speed chart, according to claim 23, wherein said bright colours are primary colours, including at least two of red, green, blue, cyan, magenta and yellow.

25. A navigation set comprising:
a speed chart having a major face and a protractor having a major face and means for mounting said protractor on said speed chart for manually controlled sliding movement of said major face of said protractor across said major face of said speed chart;
said major face of said speed chart being marked with at least one speed arc representative of at least one airspeed of an aircraft by at least one distance from a fixed point and markings representative of ground speeds of the aircraft by distances from said fixed point; said major face of said speed chart further being marked with a compass bearing line for indicating a direction of flight of the aircraft, said compass bearing line passing through said fixed point, intersecting said at least one speed arc and said markings; said major face of said speed chart further comprising a plurality of deviation angle lines, indicative of angular deviation about said fixed point of the flight of the aircraft from flying along said compass bearing line;
said major face of said protractor being made of transparent plastic for overlying on an aeronautical map and marked with a centre point; a plurality of spaced range indication lines spaced at predetermined distances from said centre point; a base line, passing through said centre point;
and, a plurality of spaced angle indication lines indicating predetermined angular displacements about said centre point and starting with said base line;
said protractor being operative to measure a velocity of wind by manual sliding adjustment across the major face of the speed chart to align the baseline along said compass bearing line with the centre point of the protractor coincident with a selected one of the markings which represents an actual ground speed of the aircraft and with a deviation angle line of the speed chart representing a deviation angle of the aircraft intersecting a selected one of the said at least one speed arc representative of the airspeed of the aircraft and, measuring a distance between the centre point and a point of intersection of the angle deviation line with the selected one speed arc; and,
said protractor being operative to measure an angular deviation of wind direction from a course represented by said compass bearing line by measuring an angle of an angle indication line of the protractor which intersects the point of intersection of the angle deviation line representing a deviation angle of the aircraft with the selected one speed arc.
